(19) United States
(12) Patent Application Publication
(10) Pub. No.: US 2009/0000624 A1
(43) Pub. Date: Jan. 1, 2009

(54) RESPIRATOR HAVING A HARNESS AND METHODS OF MAKING AND FITTING THE SAME

(75) Inventors: Heonyung Lee, Suwon-si (KR); Jin-Ho Lee, Sungnam-Si (KR); Tomoo Nagaosa, Tokyo (JP); Kyoungho Lee, Hwaseong-Si (KR); Isao Kuniya, Sagamihara-shi (JP); Koshi Yasuda, Tokyo (JP); Kiyoshi Miyashita, Tokyo (JP)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/769,768

(22) Filed: Jun. 28, 2007

(51) Int. Cl. A62B 18/08

(52) U.S. Cl. 128/207.11

(57) ABSTRACT

A respirator having a harness along with a method of making and fitting the same are disclosed. The respirator includes a mask body; and a harness attached to the mask body. The harness comprises: a first fastening strap securement mechanism that is disposed on a first side of the mask body; a second fastening strap securement mechanism that is disposed on a second side of the mask body opposing the first side; and a fastening strap attached to one of the first and second fastening strap securement mechanisms.

### BACKGROUND

The present invention is related generally to a respirator having a flexible fastening strap or the like. More particularly, it is related to a respirator including a harness for easily accommodating and securing the respirator to a wearer, as well as a method of making, and fitting the same.

It is well known to provide a respirator with a flexible fastening strap in order to mount and secure the same to a wearer's head. Wide varieties of approaches exist towards accomplishing such ends. Exemplary ones include providing a respirator that includes a mask body having a pair of fastening straps that are securable behind the wearer's head by drawing together and tying the opposing ends. Still other approaches use an elastic string fitted over the wearer's head. Yet, another approach provides a fastener, such as a clasp, hook, or other similar mechanism on the free ends of the straps/strings that allow them to be releasably secured together behind the wearer's head. Still another approach uses a pair of strap loops on the mask body, wherein the respirator is fitted over a wearer's face by pulling each of the loops over a wearer's head and positioning each of the loops behind the wearer's head to provide a good fit. Still other approaches are directed to adjusting the effective length of the fastening straps or strings to enable the respirator to be fitted properly. If a respirator is not properly fitted, there exists a possibility of increased wearer discomfort and potential minimization of the sealing engagement at the respirator's perimeter. Hence, proper fitting is important.

While known approaches serve their respective needs, there nevertheless are some shortcomings. For instance, with known respirators of the type mounted and secured from behind the wearer's head, it is at times difficult to do so especially while wearing protective headwear, such as a helmet. Moreover, with known types of behind the head mounting arrangements, there is a general inability to provide significant adjustability for their proper fitting especially in an easy and reliable manner.

Accordingly, there exists a continuing desire to provide improvements in this field, particularly in terms of providing a respirator easily mounted and removed from a wearer's head despite wearing protective headwear, and also be able to provide a wide range of adjustability for effecting a proper fit in a manner that is easy and reliable to perform.

### SUMMARY

In one exemplary embodiment of the present disclosure, provision is made for a respirator that comprises:

(a) a mask body; and (b) a harness attached to the mask body, which harness comprises: (i) a first fastening strap securement mechanism that is disposed on a first side of the mask body; (ii) a second fastening strap securement mechanism that is disposed on a second side of the mask body opposing the first side; (iii) a fastening strap attached to one of the first and second fastening strap securement mechanisms; and (iv) the other of the first and second fastening strap securement mechanisms allows for the fastening strap to be pulled thereover to be retained thereon when the respirator is being worn and also allowing for the fastening strap to be manually removed therefrom by being pulled thereover.

Another exemplary embodiment of the present disclosure provides a process for producing a respirator, the process comprising: providing a mask body adapted to fit over a wearer's face and has opposed side portions; attaching a pair of securement mechanisms to the mask body so that each one of the securement mechanisms is attached to a corresponding one of the opposed side portions; and attaching opposing end portions of a fastening strap to one of the securement mechanisms wherein the fastening strap has an intermediate portion formable into a loop which is releasably securable to the other of the securement mechanisms to be retained thereon when the respirator is being worn and also allowing for the fastening strap to be manually removed therefrom by being pulled thereover.

Another exemplary embodiment of the present disclosure provides a process of fitting a respirator to the face of a wearer, the process comprising: providing a respirator having a mask body and a harness, the harness comprising a fastening strap and a pair of securement mechanisms, one on each side of the mask body, the fastening strap having opposed end portions attached to one of the securement mechanisms, and a loop portion formed intermediate the opposed end portions for releasable securement to the other of the securement mechanisms; holding the mask body against a wearer's face with one hand; and, grabbing the loop portion with the other hand and wrapping the loop portion behind the wearer's head so as to hook the loop portion on the other of the securement mechanisms to be retained thereon when the respirator is being worn and also allowing for the fastening strap to be manually removed therefrom by being pulled thereover.

An aspect of the present disclosure is a respirator that includes a mask body and a harness for allowing the mask body to be quickly, conveniently, and securely mounted on and/or removed from a wearer.

Another aspect of the present disclosure is a respirator that includes a respirator (that has a harness for allowing the respirator body to be quickly, conveniently, and securely mounted on and/or removed from over a wearer's face even though a protective headwear, such as a helmet or the like is worn by the wearer.

Another aspect of the present disclosure is a harness of the respirator that enables making it easier for a wearer to fit and adjust the respirator body wearer's face to provide a proper fit therewith.

Another aspect of the present disclosure is a harness of the respirator that is advantageous in that the harness is very simple in design, employs a minimal number of parts, and does not have a complicated structure, whereby is construction is relatively easy to manufacture.

The foregoing aspects improve the likelihood that the wearer will be able to consistently and quickly mount the respirator over the wearer's face including nose and mouth.

The foregoing aspects improve the likelihood that a wearer thereby increasing discomfort to the wearer and potentially minimizing the engagement of the seal at the perimeter of the respirator.

The above and other aspects of the invention are more fully illustrated and described in the drawings and detailed description of this invention, where like reference numerals are used to represent similar parts. It is to be understood, however, that the description and drawings are for the purposes of illustration only and should not be read in a manner that would unduly limit the scope of this invention.

### GLOSSARY

The terms used to describe this invention have the following meanings:

“clean air” means a volume of air or oxygen that has been filtered to remove contaminants or that otherwise has been made safe to breathe;

“closed position” means the position where the flexible flap is in essentially full contact with the seal surface;

“contaminants” mean particles and/or other substances that generally may not be considered to be particles (e.g., organic vapors, et cetera) but may be suspended in air;

“doff” means to take off or remove, such as an article of clothing or the like from a person;

“don” means to put on as an article of clothing;

“exhaled air” is air that is exhaled by a filtering face mask wearer;

“exhale flow stream” means the stream of air that passes through an orifice of an exhalation valve during an exhalation;

“exhalation valve” means a valve that opens to allow a fluid to exit the interior gas space of a filtering face mask;

“exterior gas space” means the ambient atmospheric gas space into which exhaled gas enters after passing through and beyond the exhalation valve;

“filtering face mask” means a respiratory protection device (including half and full face masks and hoods) that covers at least the nose and mouth of a wearer and that is capable of supplying clean air to a wearer;

“flap” means a dynamic element that changes position in response to a force from a moving fluid, such as air from an exhale flow stream;

“flexible flap” means a sheet-like article that is capable of bending or flexing in response to a force exerted from a moving fluid, which moving fluid, in the case of an exhalation valve, would be an exhale flow stream and in the case of an inhalation valve would be an inhale flow stream;

“harness” means a supporting arrangement comprising at least one fastening strap and at least one fastening strap connector element that interact together for holding something, such as a mask body together;

“protective headwear” means an article, such as a helmet, hard hat, hood, etc, that is worn on a person's head for safety or protection purposes;

“inhalation valve” means a valve that opens to allow a fluid to enter a filtering face mask's interior gas space;

“interior gas space” means the space between a mask body and a person's face;

“mask body” means a structure that can fit at least over the nose and mouth of a person and that helps define an interior gas space separated from an exterior gas space;

“particles” mean any liquid and/or solid substance that is capable of being suspended in air, for example, pathogens, bacteria, viruses, mucous, saliva, blood, etc.;

“respirator” means a device for covering all or part of the face used for filtering inhaled air or to supply gas for inhalation for a wearer;

“seal surface” means a surface that makes contact with the flap when the valve is in its closed position;

“fastening strap” means an elongated flexible strip off a material that has elastic characteristics, such as plastics including isoprene, polyisoprene and natural rubber of the like that is formable as a loop and used to bind or secure something.

### BRIEF DESCRIPTION OF THE DRAWINGS

The aforementioned aspects and other features of the present invention are described in detail in conjunction with the accompanying drawings in which the same reference numerals are used throughout several views for denoting the same structure.

FIG. 1 is a front perspective view of one exemplary embodiment of a respirator including a mask body and harness made according to the present invention.

FIG. 2 is a rear perspective view of the respirator in FIG. 1.

FIG. 3 is a front perspective view of a respirator as illustrated in FIG. 1 being worn by a wearer.

FIG. 4 is rear perspective view illustrating of a connecting anchor of the respirator of FIG. 1.

FIG. 5 is a left front perspective view of a harness made according to the invention.

FIG. 6 is a top perspective view of one of the anchor components of the harness.

FIG. 7 is bottom perspective view of the anchor component of FIG. 6.

FIG. 8 is a front perspective view of the anchor component of FIG. 6.

### DETAILED DESCRIPTION

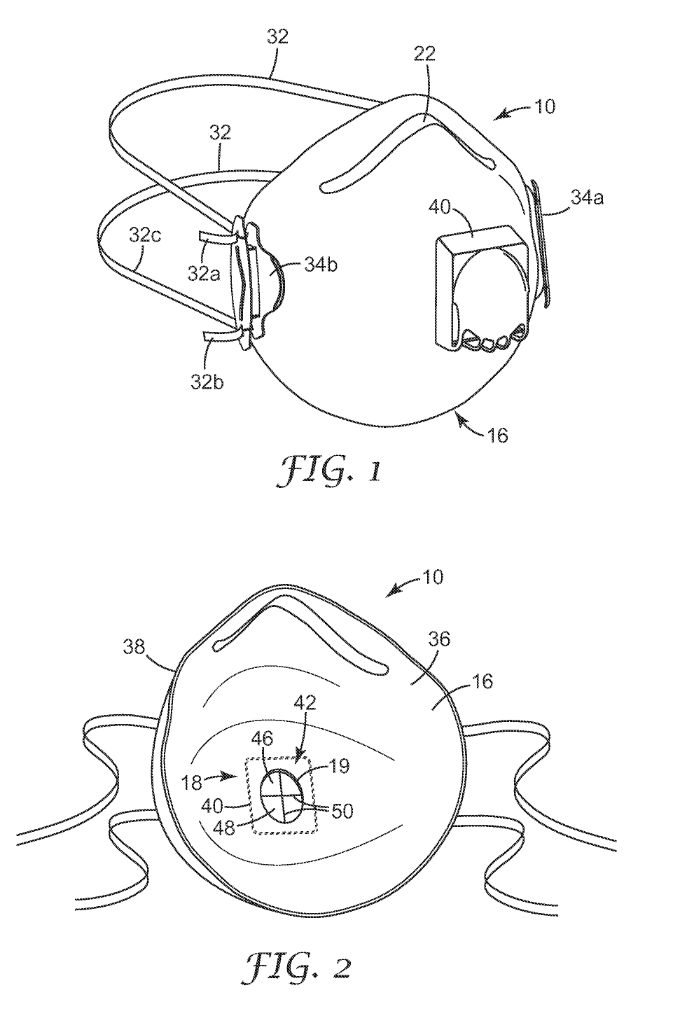

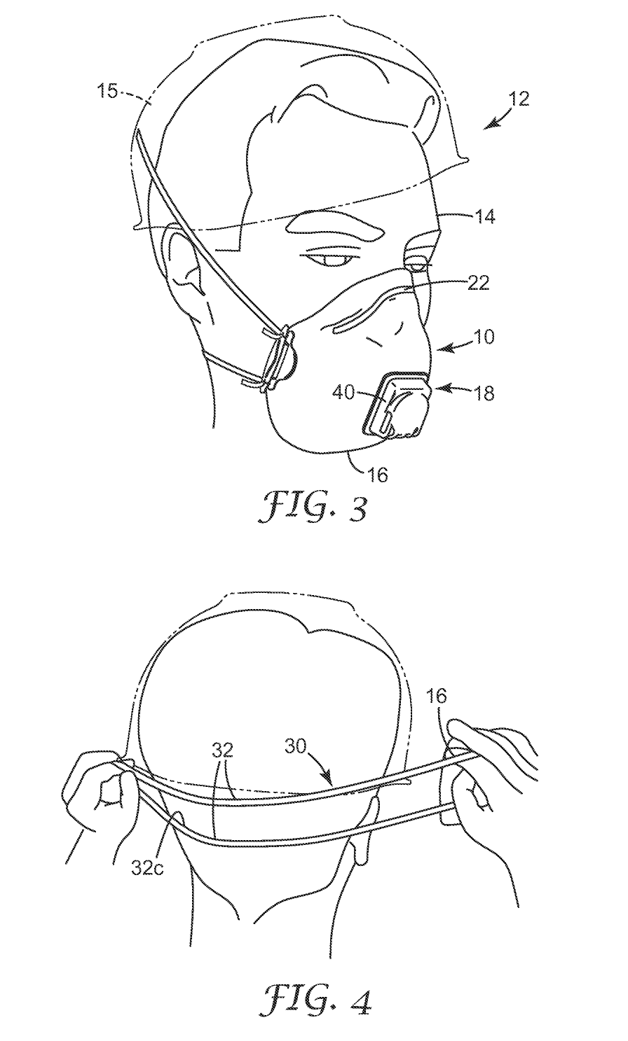

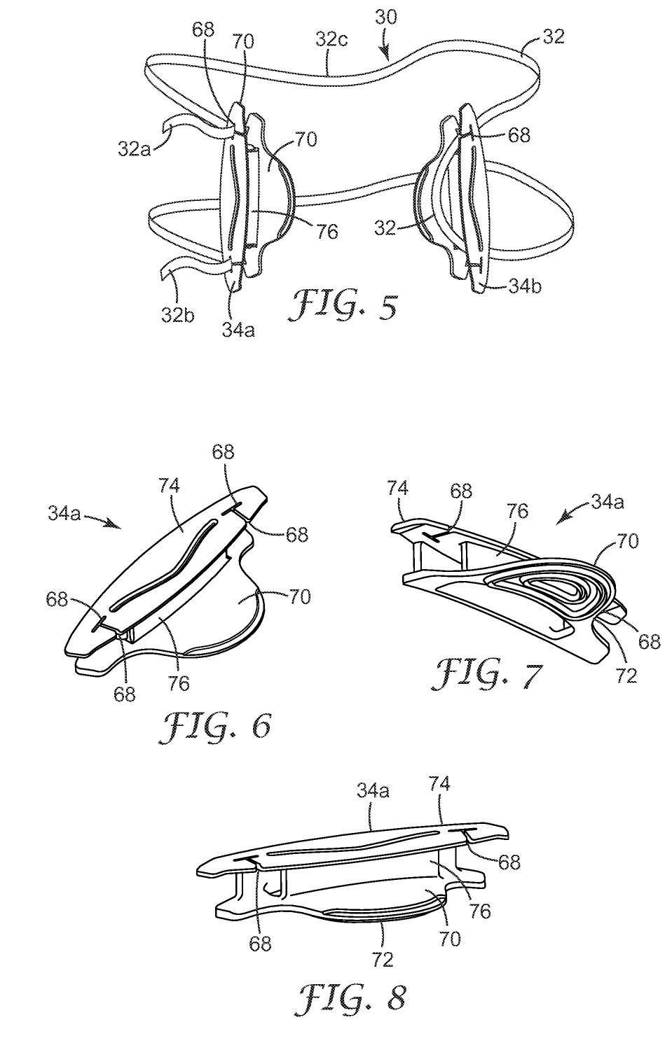

FIGS. 1-8 illustrate an exemplary embodiment of a respirator 10 made according to the principles of the present disclosure that facilitates fitting and adjusting on a wearer. As illustrated in FIGS. 3 and 4, a wearer 12 may advantageously don and doff the respirator 10 to and from a wearer's head 14 even while protective headwear 15, such as a helmet 15 or the like is worn. This is highly advantageous since a user need not remove the protective headwear during mounting and removal of the respirator. In addition, the respirator 10 is easily adjusted to accommodate different sized wearers for providing a secure and comfortable fit that enhances safety.

The respirator 10 of FIGS. 1-8 may be a filtering face mask 10 similar to that described in commonly assigned U.S. Pat. No. 7,028,689; which is incorporated herein. The filtering face mask 10 has a cup-shaped mask portion 16 onto which an exhalation valve 18 is attached using any suitable technique, including, for example, the technique described in U.S. Pat. No. 6,125,849 to Williams et al. The filtering face mask 10 may cover all or part of a face for protection or hygiene. The exhalation valve 18 opens in response to increased pressure inside the respirator 10, which increased pressure occurs when a wearer exhales. The exhalation valve 18 typically remains closed between breaths and during an inhalation.

The mask body 16 is adapted to fit over the nose and mouth of a person in spaced relation to the wearer's face to create an interior gas space or void (not shown) between the wearer's face and the interior surface of the mask body. The mask body 16 is fluid permeable and typically is provided with an opening 19 (FIG. 2) that is located where the exhalation valve 18 is attached to the mask body 16 so that exhaled air can exit the interior gas space through the exhalation valve 18 without having to pass through the mask body 16. One typical location of the opening 19 on the mask body 16 is directly in front of where the wearer's mouth would be when the mask is being worn. The placement of the opening 19, and hence the exhalation valve 18, at this location allows the valve to open more easily in response to the exhalation pressure generated by a wearer of the respirator 10. For a mask body 16 of the type illustrated in this FIG. 1, essentially the entire exposed surface of mask body 16 is fluid permeable to inhaled air.

A nose clip 22 that comprises a pliable and soft band of metal, such as aluminum, can be provided on the mask body 16 to allow it to be shaped to hold the filtering face mask 10 in a desired fitting relationship over the nose and mouth of the wearer. An example of a suitable nose clip is illustrated in U.S. Pat. No. 5,558,089.

Mask body 16 can have a curved, hemispherical shape as illustrated in FIGS. 1-3. However, the mask body 16 may take essentially any appropriate form depending on end use. While the mask body 16 can be a cup-shaped mask having a construction like that depicted, it can also have the three-fold configuration that can fold flat when not in use but can open into a cup-shaped configuration when worn—see U.S. Pat. No. 6,123,077 to Bostock et al., and U.S. Pat. No. Des. 431,647 to Henderson et al., Des. 424,688 to Bryant et al. Face masks of the invention also may take on many other configurations, such as flat bifold masks disclosed in U.S. Pat. No. Des. 443,927 to Chen. The mask body 16 also could be fluid impermeable and have filter cartridges attached to it like the mask illustrated in U.S. Pat. No. 5,062,421. In addition, the mask body 16 also could be adapted for use with a positive pressure air intake as opposed to the negative pressure masks just described. Examples of positive pressure masks are illustrated in U.S. Pat. No. 5,924,420 to Grannis et al. and U.S. Pat. No. 4,790,306 to Braun et al. The mask body of the filtering face mask also could be connected to a self-contained breathing apparatus, which supplies clean air to the wearer as disclosed, for example, in U.S. Pat. Nos. 5,035,239 and 4,971,052. The mask body may be configured to cover not only the nose and mouth of the wearer (referred to as a “half mask”) but may also cover the eyes (referred to as a “full face mask”) to provide protection to a wearer's vision as well as to the wearer's respiratory system—see, for example, U.S. Pat. No. 5,924,420 to Reischel et al. The mask body may be spaced from the wearer's face, or it may reside flush or in close proximity to it. In either instance, the mask helps define an interior gas space into which exhaled air passes before leaving the mask interior through the exhalation valve. The mask body also could have a thermochromic fit-indicating seal at its periphery to allow the wearer to easily ascertain if a proper fit has been established—see U.S. Pat. No. 5,617,849 to Springett et al.

To hold the filtering face mask 10 snugly upon the wearer's face, the mask body 16 is provided with a harness 30 that includes a fastening strap 32 and a pair of fastening securement mechanisms 34a, b. FIGS. 1-3 illustrate that the mask body 16 may comprise multiple layers, such as an inner shaping layer 36 and an outer filtration layer 38. The shaping layer 36 provides structure to the mask body 16 and supports for the outer filtration layer 38. The shaping layer 36 may be located on the inside and/or outside of filtration layer 38 (or on both sides) and can be made, for example, from a nonwoven web of thermally—bondable fibers molded into a cup-shaped configuration—see U.S. Pat. No. 4,807,619 to Dyrud et al. and U.S. Pat. No. 4,536,440 to Berg. It can also be made from a porous layer or an open work “fishnet” type network of flexible plastic like the shaping layer disclosed in U.S. Pat. No. 4,850,347 to Skov. The shaping layer can be molded in accordance with known procedures, such as those described in Skov or in U.S. Pat. No. 5,307,796 to Kronzer et al. Although the shaping layer 36 provides structure to the mask and provides support for a filtration layer, it may also act as a filter typically for capturing larger particles. Together the inner and outer filter layers 36 and 38; respectively operate as an inhale filter element. Hence, when a wearer inhales, air is drawn through the mask body 16, and airborne particles become trapped in the interstices between the fibers, particularly the fibers in the outer filter layer 38. In FIG. 2, the outer filter layer 38 is integral with the mask body 16—that is, it forms part of the mask body and is not an item that subsequently becomes attached to (or removed from) the mask body like a filter cartridge.

Filtering materials that are commonplace on negative pressure half mask respirators —like the respirator 10 illustrated in FIG. 1—often contain an entangled web of electrically charged microfibers, particularly meltblown microfibers (BMF). Examples of fibrous materials that may be used as filters in a mask body are disclosed in U.S. Pat. No. 5,706,804 to Baumann et al., U.S. Pat. No. 4,419,993 to Peterson, U.S. Reissue Pat. No. Re 28,102 to Mayhew, U.S. Pat. Nos. 5,472,481 and 5,411,576 to Jones et al., and U.S. Pat. No. 5,908,598 to Rousseau et al. The fibers may contain polymers, such as polypropylene and/or poly4-methyl-1-pentene (see U.S. Pat. No. 4,874,399 to Jones et al. and U.S. Pat. No. 6,057,256 to Dyrud et al.) and may also contain fluorine atoms and/or other additives to enhance filtration performance—see, U.S. patent application Ser. No. 09/109,497, entitled Fluorinated Electret (published as PCT WO 00/01737), and U.S. Pat. Nos. 5,025,052 and 5,099,026 to Crater et al., and may also have low levels of extractable hydrocarbons to improve performance; see, for example, U.S. Pat. No. 6,213,122 to Rousseau et al. Fibrous webs also may be fabricated to have increased oily mist resistance as described in U.S. Pat. No. 4,874,399 to Reed et al., and in U.S. Pat. Nos. 6,238,466 and 6,068,799, both to Rousseau et al.

The exhalation valve 18 can be secured to the mask body using a variety of techniques, such as ultrasonic welding, gluing, adhesive bonding (see U.S. Pat. No. 6,125,849 to Williams et al.), or mechanical clamping. The exhalation valve 18 includes a valve seat 40 and a valve flap 42 (FIG. 2) that controls the flow of air. The valve seat 40 typically is made from a relatively lightweight plastic that is molded into an integral one-piece body. The valve seat 40 can be made by injection molding techniques. The seal surface that makes contact with the valve flap 42 is typically fashioned to be substantially uniformly smooth to ensure that a good seal occurs. The flap 42 opens in response to increased pressure inside the respirator 10, which increased pressure occurs when a wearer exhales. The exhalation valve 18 typically remains closed between breaths and during an inhalation. The flap 42 can be a flexible flap that has a free portion 46 that lifts from the valve seat 40 during an exhalation. When the free portion 46 is not in contact with the valve seat 40, exhaled air may pass from the interior gas space to an exterior gas space. The exhaled air may pass directly into the exterior gas space, or it may take a more tortuous path if, for example, the mask also includes an impactor element or it includes a filtered exhalation valve. The seal surface circumscribes or surrounds the orifice 48 to prevent the undesired passage of contaminates through it. Seal surface and the valve orifice 48 can take on essentially any shape when viewed from the front. For example, the seal surface and the valve orifice 48 may be square, rectangular, circular, elliptical, etc. The shape of seal surface does not have to correspond to the shape of valve orifice 48 or vise versa.

When a wearer of a filtering face respirator 10 exhales, the exhaled air commonly passes through both the mask body 16 and the exhalation valve 18. Comfort is best obtained when the highest percentage of the exhaled air passes through the exhalation valve 18, as opposed to the filter media and/or shaping and cover layers in the mask body. Exhaled air is expelled from the interior gas space through an orifice 48 in the exhalation valve 18 by having the exhaled air lift the flexible valve flap 42 from the seal surface. Cross members 50 stabilize the seal surface and ultimately the exhalation valve 18. The cross members 50 also can prevent the flap 42 (FIG. 2) from inverting into the valve orifice 48 during inhalation.

While the present exemplary embodiment utilizes an exhalation valve, the present disclosure envisions that an inhalation valve may be utilized or for that matter, other apparatus for respiratory control may be used instead.

Reference is made to the harness 30 of one exemplary embodiment that is adapted to mount and dismount the respirator 10 as well as provide adjustment thereof. The harness 30 employs a minimal number of parts, which do not have a complicated structure and are relatively easy to manufacture and use. As noted earlier, the harness 30 includes a single fastening strap 32 and a pair of fastening strap securement mechanisms 34a, b that are attached to opposing side portions of the mask body 16 for cooperating with the fastening strap 32 as illustrated. As will be described, the harness 30 allows the respirator 10 to be mounted and dismounted from a wearer and yet affords significant ease in adjusting the respirator to mask body, particularly when a helmet 15 or the like is being worn.

In this exemplary embodiment, the fastening strap securement mechanisms 34a, b is identical and, hence only a description of one is presented herein. The fastening strap 32 has opposed end portions 32a, 32b that are adapted to cooperate with either one of the fastening strap securement mechanisms in a manner to be described. The fastening strap 32 is adapted to form a loop portion 32c intermediate the end portions 32a, 32b.

The fastening strap 32 may be a flexible member that has elastic characteristics. The fastening strap 32 can be made of a variety of materials. For example, typical materials include isoprene, polyisoprene, and natural rubber. Other typical materials include Spandex™ and Neoprene™. For wearers with allergic reaction to certain materials, elastic rubber material braided with a fabric like polyester which provides comfortable feeling as well. The elastic fastening strap 32 helps keep the mask body 16 in its desired position on the wearer so that a proper fit is accomplished. The fastening strap 32 is a generally thin member that cooperates with slits 68 having a configuration as illustrated (e.g., T-shaped) that are formed in the strap securement mechanism, as will be described.

The strap securement mechanism 34a may be a molded plastic, single-piece member that includes a generally enlarged base portion 70 including a bottom surface 72. The bottom surface 72 may be heat bonded to the outer layer through appropriate means. Alternatively, the bottom surface 72 may be adhesively connected to the outer layer of the mask body 16. The fastening strap securement mechanism includes a generally flat top retaining portion 74. The base portion 70 and the retaining portion 74 are connected together by a bridging element 76. The bridging element 76 spaces them apart from each other by a distance that accommodates the width of the fastening strap 32 when retaining the respirator. Formed in the retaining portion 74 as illustrated is the pair of spaced apart slits 68. The slits 68 are sized to accommodate the insertion, removal, and displacement of the fastening strap 32 therefrom. A wearer places end portions of the fastening strap into respective ones of slits. The slit causes the fastening strap to remain stationary unless acted upon by frictional forces. Such frictional forces tend to keep the fastening strap in one position unless the respective ones of the free ends are pulled. Once the ends are pulled, the loop is diminished or enlarged in size accordingly. In this manner, the harness 30 is adjustable, whereby the mask body 16 is fitted to the wearer in order to make an effective seal against the wearers' face. Because the strap securement mechanisms are identical, the mounting is reversible in that a user can mount the strap so that the end portions are coupled to either one of the strap securement mechanism. In use then, the user can wrap the loop portion 32c around the back of the head and secure the loop to the other strap securement mechanism.

This is highly advantageous in that it minimizes the number and complexity of manipulations to mount and dismount from a wearer's head. Moreover, the strap securement mechanism 34a is located adjacent a front side of the respirator 10. As such, the adjustments may be made more easily with the user being able to see and grasp the end portions of the strap. Accordingly, adjustment need not be made with the hands in the back of the head. As such, a convenient and reliable approach to obtain an excellent fit over a wide range of face sizes is provided. While identical strap securement mechanisms are illustrated, non-identical strap securement mechanisms may be provided. For example, one of the strap securement mechanisms may be provided with slit and the other strap securement mechanism is provided with a retainer member for retaining the loop portion in hooked relationship.

After having explained the construction of the respirator 10, the fitting thereof relative to a wearer is described. In the respirator 10 of the invention, the harness 30 is attached to the mask body 16. One end of the fastening strap 32 slidably passes thought the slits 68 of one securement mechanism to secure the respirator 10 to the mask body 16 on one side of the wearer's face. To mount the respirator 10, the wearer holds the mask body 16 with one hand against the wearer's face. With the other hand, the wearer grabs the loop portion and wraps it behind the wearer's head to hook it on the other securement mechanism. Advantageously, this may be performed while the wearer is wearing a helmet. This adds to safety. The frictional engagement between the fastening strap and the harness allows the respirator to snuggly secure the respirator to the wearer's face. Accordingly, the respirator 10 is mounted on the wearer.

For effectuating a proper fit, the wearer can pull on the opposed end portions of the fastening strap 32 to either expand or contract the loop portion, thereby accommodating the wearer's comfort and size. When the wearer desires to remove the respirator 10, one hand merely holds the mask body 16 as before, while the other hand unhooks the fastening strap 32 off the other securement mechanism.

It is to be understood that the above described exemplary embodiments are merely illustrative of the present invention and represent but a limited number of possible specific embodiments that can be provide applications of the principles of the invention. Numerous and varied other arrangements may be readily devised in accordance with these principles by those skilled in the art without departing from the spirit and scope of the invention as claimed.

What is claimed is:

1. A respirator that comprises:
(a) a mask body; and
(b) a harness attached to the mask body, which harness comprises:
(i) a first fastening strap securement mechanism that is disposed on a first side of the mask body; (ii) a second fastening strap securement mechanism that is disposed on a second side of the mask body opposing the first side; iii) a fastening strap attached to one of the first and second fastening strap securement mechanisms; and
(iv) the other of the first and second fastening strap securement mechanisms allows for the fastening strap to be pulled thereover to be retained thereon when the respirator is being worn and also allowing for the fastening strap to be manually removed therefrom by being pulled thereover.

2. The respirator of claim 1, wherein both the first and second fastening strap securement mechanisms include portions that frictionally retain corresponding end portions of the fastening strap therein, whereby the end portions are movable with respect thereto for allowing adjustment of the size of the fastening strap relative to the mask portion to accommodate a wearer.

3. The respirator of claim 1, wherein both the first and second fastening strap securement mechanisms include a base portion attachable to the mask body, and a strap retaining portion that is spaced from the base portion so as to allow a loop portion of the fastening strap to be pulled thereover and therefrom.

4. The respirator of claim 2, wherein the portions that frictionally retain corresponding end portions are slits.

5. The respirator of claim 1, wherein the mask portion is a filtering face mask.

6. The respirator of claim 1, wherein each of the securement mechanisms is made of a plastic material.

7. The respirator of claim 1, wherein the fastening strap is an elongated and elastic member.

8. The respirator of claim 1, wherein the fastening strap is made of materials of a group comprising: isoprene, polyisoprene, natural rubber, Spandex™, Neoprene™, and elastic rubber material braided material with a fabric.

9. The respirator of claim 8, wherein the first and second strap securement mechanisms are located adjacent side portions of the mask body so that the portions that frictionally engage the end portions of the fastening strap present the end portions in such a manner that a wearer can observe and grasp the end portions.

10. A harness attachable to a mask body of a respirator, the harness comprises:
a fastening strap having end portions;
a first fastening strap securement mechanism that is attachable on a first side of the mask body; and
a second fastening strap securement mechanism that is attachable on a second opposing side of the mask, the second fastening strap securement mechanism allowing for the fastening strap to be pulled thereover to be retained thereon when the respirator is being worn and also allowing for the fastening strap to be manually removed therefrom by being pulled thereover.

11. The harness of claim 10, wherein both the first and second fastening strap securement mechanisms include portions that frictionally retain corresponding end portions of the fastening strap therein, whereby the end portions are movable with respect thereto for allowing adjustment of the harness.

12. The harness of claim 10, wherein both the first and second fastening strap securement mechanisms include a body portion attachable to the mask body, and a strap retaining portion that is spaced from the body portion so as to allow a loop portion of the fastening strap intermediate the end portions to be pulled thereover and therefrom.

13. The harness of claim 10, wherein the portions that frictionally retain corresponding end portions are slits.

14. The harness of claim 10, wherein the mask portion is a filtering face mask.

15. The harness of claim 10, wherein each of the first and second fastening strap securement mechanisms is made of a plastic material.

16. The harness of claim 10, wherein the fastening strap is an elongated and elastic member.

17. The respirator of claim 16, wherein the fastening strap is made of materials of a group comprising: isoprene, polyisoprene, natural rubber, Spandex™, Neoprene™, and elastic rubber material braided material with a fabric.

18. A process for producing a respirator, the process comprising:
providing a mask portion adapted to fit over a wearer's face and has opposed side portions;
attaching a pair of securement mechanisms to the mask portion so that each one of the securement mechanisms is attached to a corresponding one of the opposed side portions;
attaching end portions of a fastening strap to one of the pair of securement mechanisms wherein the fastening strap has an intermediate portion formable into a loop which is releasably securable to the other of the pair of securement mechanisms to be retained thereon when the respirator is being worn and also allowing for the fastening strap to be manually removed therefrom by being pulled thereover.

19. The process of claim 18, wherein the attaching of the end portions of the fastening strap includes providing both of the securement mechanisms with slits, and placing each of the end portions of the fastening strap through respective one of the slits of one the securement mechanisms.

20. The process of fitting a respirator to the face of a wearer, the process comprising:
providing a respirator having a mask body and a harness, the harness comprising a fastening strap and a pair of securement mechanisms, one on each side of the mask body, the fastening strap having opposed end portions attached to one of the securement mechanisms, and a loop portion formed intermediate the opposed end portions for releasable securement to the other of the securement mechanisms;
holding the mask body with one hand so as to be placed upon the wearer's face;
grabbing the loop portion and wrapping it behind the wearer's head with the other hand so as to hook the loop portion on the other of the securement mechanisms to be retained thereon when the respirator is being worn and also allowing for the fastening strap to be manually removed therefrom by being pulled thereover.

21. The process of claim 20, wherein adjusting of the mask body to a wearer is performed by pulling on the opposed end portions relative to the one securement mechanism so as to expand or contract the size of the loop portion.

22. The process of claim 21, wherein the respirator is removable by holding on the mask body with one hand, and unhooking the loop portion from the other securement mechanism with the other hand.
